(19) United States
(12) Patent Application Publication
(10) Pub. No.: US 2026/0158864 A1
(43) Pub. Date: Jun. 11, 2026

(54) HEAT MANAGEMENT SYSTEM AND VEHICLE

(71) Applicant: TOYOTA JIDOSHA KABUSHIKI KAISHA, Toyota-shi (JP)

(72) Inventor: Takayuki KAWABE, Toyota-shi (JP)

(73) Assignee: TOYOTA JIDOSHA KABUSHIKI KAISHA, Toyota-shi (JP)

(21) Appl. No.: 19/384,291

(22) Filed: Nov. 10, 2025

(30) Foreign Application Priority Data
Dec. 6, 2024 (JP) 2024-213292

(51) Int. Cl. B60H 1/00

(52) U.S. Cl. CPC B60H 1/00899

(57) ABSTRACT

A heat management system includes a battery that performs heat exchange with a heat medium in a F4 flow passage, a transaxle that performs heat exchange with a heat medium in a F2 flow passage, and a switching device. The switching device forms a thermal circuit in which the F4 flow passage and the F2 flow passage are connected, after a temperature rise control, in a case that a detection value of a flow passage sensor that detects the temperature of the heat medium in the F4 flow passage is less than a threshold Tb. The switching device forms a thermal circuit including the F4 flow passage isolated from the F2 flow passage, after the temperature rise control, in a case that the detection value of the flow passage sensor is more than or equal to a threshold Tb and less than or equal to a threshold Tc.

### CROSS-REFERENCE TO RELATED APPLICATION

This application claims priority to Japanese Patent Application No. 2024-213292 filed on December 6, 2024. The disclosure of the above-identified application, including the specification, drawings, and claims, is incorporated by reference herein in its entirety.

### BACKGROUND

### 1. Technical Field

The present disclosure relates to a heat management system and a vehicle.

### Description of Related Art

WO 2024-105802 discloses a motor control system for a battery electric vehicle including a battery and a motor. In the motor control system, the battery is warmed by coolant having a temperature that is raised by the heat generation of the motor.

### SUMMARY

In WO 2024-105802, the control to perform the temperature rise (warming) of the battery is performed as described above. When the temperature rise of the battery is performed, the temperatures of a plurality of electric storage cells included in the battery vary in some cases. In order to eliminate the variation in temperature among the electric storage cells, it is possible that heat exchange is performed between the battery and a heat medium, such as coolant. It is desirable to restrain the temperature of the battery from excessively rising (falling) due to the heat exchange between the battery and the heat medium.

The present disclosure provides a heat management system and a vehicle that make it possible to restrain the temperature of an electric storage device from excessively rising (falling), while restraining the variation in temperature among a plurality of electric storage cells.

A heat management system according to a first aspect of the present disclosure includes a first flow passage, a second flow passage, and a third flow passage that is configured such that a heat medium flows, an electric storage device configured to perform heat exchange with the heat medium in the first flow passage and including a plurality of electric storage cells, a drive device configured to perform heat exchange with the heat medium in the second flow passage and being able to generate drive power, a heat exchanger provided at the third flow passage, a switching device configured to switch a connection state among the first flow passage, the second flow passage, and the third flow passage, and a medium-temperature detection device configured to detect the temperature of the heat medium that flows through the first flow passage. The switching device is configured to form a first flow passage circuit after a temperature rise control, in a case that a detection value of the medium-temperature detection device is less than a first threshold, and form a second flow passage circuit after the temperature rise control, in a case that the detection value of the medium-temperature detection device is in a temperature range that is more than or equal to the first threshold and less than or equal to a second threshold that is more than the first threshold, the first flow passage circuit being a circuit including the first flow passage and the second flow passage that are connected to each other and being isolated from the third flow passage, the second flow passage circuit being a circuit including the first flow passage that is isolated from the second flow passage, the temperature rise control being a control to perform temperature rise of the electric storage device.

In the heat management system according to the first aspect of the present disclosure, after the temperature rise control, in a case that the detection value of the medium-temperature detection device is less than the first threshold, the first flow passage circuit is formed. In this case, it is possible to perform the temperature rise of the heat medium in the first flow passage circuit using the heat of the drive device, while restraining the variation in temperature among the electric storage cells using the heat medium in the first flow passage circuit. As a result, it is possible to restrain the temperature of the electric storage device from excessively falling, while restraining the variation in temperature among the electric storage cells. Further, in the heat management system according to the first aspect of the present disclosure, after the temperature rise control, in a case that the detection value of the medium-temperature detection device is in the temperature range that is more than or equal to the first threshold and less than or equal to the second threshold, the second flow passage circuit is formed. In this case, it is possible to restrain the temperature of the electric storage device from rising due to the heat of the drive device, while restraining the variation in temperature among the electric storage cells using the heat medium in the second flow passage circuit. As a result, it is possible to restrain the temperature of the electric storage device from excessively rising, while restraining the variation in temperature among the electric storage cells.

The second flow passage circuit may be a circuit in which the first flow passage is isolated from a circuit in which the second flow passage and the third flow passage are connected. With this configuration, when the second flow passage circuit is formed, it is possible to release the heat of the drive device to the exterior through the heat exchanger.

The switching device may be configured to form a third flow passage circuit after the temperature rise control, when the detection value of the medium-temperature detection device is more than the second threshold, the third flow passage circuit being a circuit in which the first flow passage, the second flow passage, and the third flow passage are connected. With this configuration, when the third flow passage circuit is formed, it is possible to release the heat of the heat medium that flows through the first flow passage, to the exterior through the heat exchanger, while releasing the heat of the drive device to the exterior through the heat exchanger. As a result, it is possible to restrain the temperature of the electric storage device from excessively rising, while cooling the drive device.

The heat management system may further include a cell-temperature detection device configured to detect temperatures of at least two electric storage cells of the electric storage cells. The switching device may be configured to form the first flow passage circuit after the temperature rise control, in a case that a value based on a difference between the temperatures of the at least two electric storage cells that are detected by the cell-temperature detection device is more than or equal to a cell-temperature threshold and the detection value of the medium-temperature detection device is less than the first threshold, and may be configured to form the second flow passage circuit after the temperature rise control in a case that the value based on the difference is more than or equal to the cell-temperature threshold and the detection value of the medium-temperature detection device is in the temperature range. With this configuration, it is possible to switch whether the first flow passage circuit (second flow passage circuit) is formed, depending on the variation in temperature among the electric storage cells.

The switching device may form a third flow passage circuit after the temperature rise control, when the value based on the difference is more than or equal to the cell-temperature threshold and the detection value of the medium-temperature detection device is more than the second threshold, the third flow passage circuit being a circuit in which the first flow passage, the second flow passage, and the third flow passage are connected. In this configuration, it is possible to switch whether the third flow passage circuit is formed, depending on the variation in temperature among the electric storage cells.

The heat management system may further include a pump configured to circulate a heat medium through the second flow passage, a processor configured to control drive of the pump, and a device-temperature detection device configured to detect the temperature of the drive device. The processor may be configured to stop the pump after the temperature rise control, in a case that the value based on the difference is more than or equal to the cell-temperature threshold, that the second flow passage circuit or the third flow passage circuit has been formed, and that the temperature of the device-temperature detection device is less than a threshold. The processor may be configured to drive the pump after the temperature rise control, in a case that the value based on the difference is more than or equal to the cell-temperature threshold, the second flow passage circuit or the third flow passage circuit has been formed, and the temperature of the device-temperature detection device is more than or equal to the threshold. With this configuration, when the temperature of the drive device is relatively low, the pump is stopped, and thereby, it is possible to prevent the drive device from being cooled due to the circulation of the heat medium. Further, when the temperature of the drive device is relatively high, the pump is driven, and thereby, it is possible to cool the drive device by the circulation of the heat medium.

The heat management system may further include a device-temperature detection device configured to detect the temperature of the drive device. The switching device may be configured to form the second flow passage circuit after the temperature rise control, in a case that the value based on the difference is less than the cell-temperature threshold and a detection value of the device-temperature detection device is more than or equal to a threshold. With this configuration, when the variation in temperature among the electric storage cells is relatively small, the first flow passage circuit is formed, and thereby, it is possible to prevent the connection between the first flow passage and the second flow passage. As a result, it is possible to restrain the heat of the drive device having a relatively high temperature from moving to the electric storage device. Thereby, it is possible to restrain increases in the variation in temperature among the electric cells.

The heat management system may further include a device-temperature detection device configured to detect the temperature of the drive device. The switching device may be configured to form the first flow passage circuit after the temperature rise control, in a case that a detection value of the device-temperature detection device is more than or equal to a threshold and the detection value of the medium-temperature detection device is less than the first threshold, may be configured to form the second flow passage circuit after the temperature rise control, in a case that the detection value of the device-temperature detection device is more than or equal to the threshold and the detection value of the medium-temperature detection device is in the temperature range, and may be configured to form the third flow passage circuit after the temperature rise control, in a case that the detection value of the device-temperature detection device is more than or equal to the threshold and the detection value of the medium-temperature detection device is more than or equal to the second threshold. In this configuration, by forming the first flow passage circuit, it is possible to use the heat of the drive device, for the temperature rise of the heat medium in the first flow passage. By forming the second flow passage circuit, it is possible to restrain the heat of the drive device from causing the temperature rise of the heat medium in the first flow passage, while releasing the heat of the drive device to the exterior through the heat exchanger. By forming the third flow passage circuit, it is possible to release the heat of the drive device and the heat of the heat medium in the first flow passage to the exterior through the heat exchanger.

The heat exchanger may further include a radiator. In this configuration, it is possible to cool the drive device by external air through the radiator. Thereby, it is possible to restrain the consumption of the electric power for the cooling of the drive device from becoming large.

The heat management system may further include an oil cooler disposed at the second flow passage, and a fourth flow passage connected to the oil cooler and isolated from the second flow passage. Lubricant is circulated through the fourth flow passage. The drive device includes a first device configured to perform heat exchange with the lubricant that is circulated through the fourth flow passage, and a second device configured to perform heat exchange with a heat medium that is circulated through the second flow passage. In this configuration, when the first flow passage circuit is formed, it is possible to perform the temperature rise of the heat medium that is circulated through the first flow passage, by the heat of both of the first device and the second device. As a result, it is possible to enhance the efficiency of the temperature rise of the heat medium, compared to when the temperature rise of the heat medium that is circulated through the first flow passage is performed by the heat of one of the first device and the second device.

A vehicle according to a second aspect of the present disclosure includes the heat management system according to the first aspect. Thereby, it is possible to provide a vehicle that makes it possible to restrain the temperature of the electric storage device from excessively rising (falling), while restraining the variation in temperature among the electric storage cells.

With the present disclosure, it is possible to restrain the temperature of the electric storage device from excessively rising (falling), while restraining the variation in temperature among the electric storage cells.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing a heat management system according to an embodiment;

FIG. 2 is a diagram showing a configuration of a vehicle that is equipped with the heat management system according to the embodiment;

FIG. 3 is a diagram showing a configuration of a first pattern in the heat management system;

FIG. 4 is a diagram showing a configuration of a second pattern in the heat management system;

FIG. 5 is a diagram showing a configuration of a third pattern in the heat management system;

FIG. 6 is a flowchart showing a switching control for a flow passage by the heat management system;

FIG. 7 is a flowchart showing a modification of FIG. 6;

FIG. 8 is a diagram showing a first modification of FIG. 3;

FIG. 9 is a diagram showing a second modification of FIG. 3; and

FIG. 10 is a diagram showing a third modification of FIG. 3.

### DETAILED DESCRIPTION OF EMBODIMENTS

An embodiment of the present disclosure will be described in detail with reference to the drawings. In the drawings, identical or corresponding portions are denoted by identical reference characters, and descriptions thereof are not repeated.

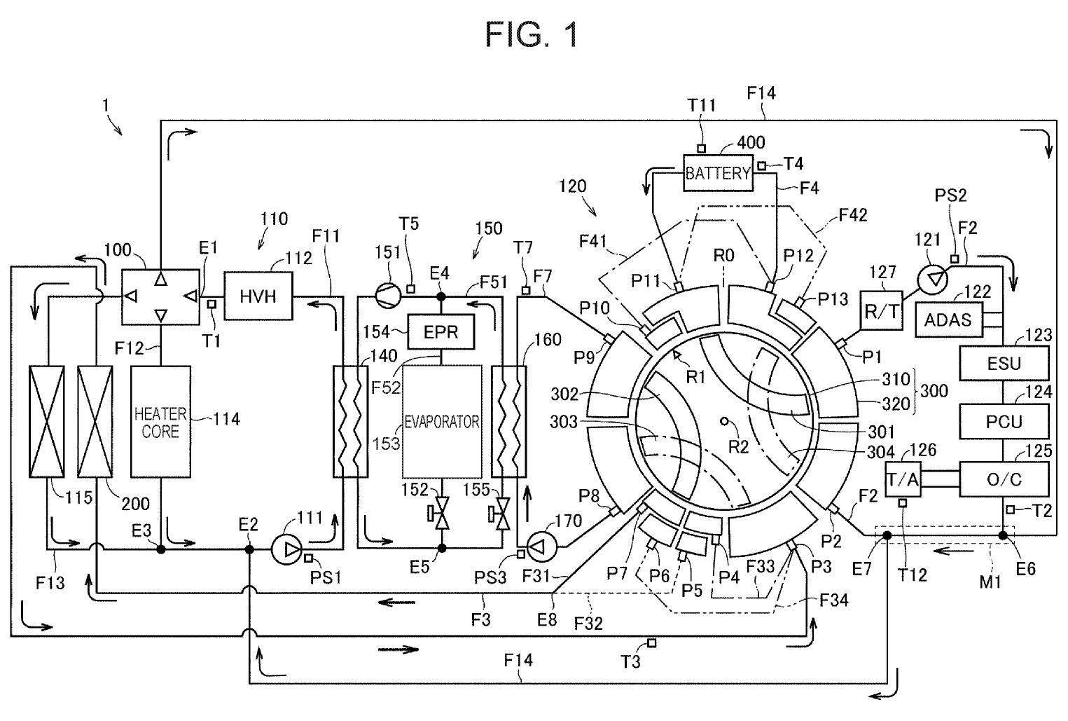

FIG. 1 is a diagram showing an overall configuration of a heat management system according to the embodiment. As shown in FIG. 1, a heat management system 1 includes thermal circuits 110, 120, 150.

The thermal circuit 110 includes flow passages F11 to F14 and a switching device 100. One end of each of the flow passages F11 to F14 is connected to the switching device 100. The switching device 100 includes one input port and three output ports. The switching device 100 may be a four-way valve (for example, a flow regulation valve in which the total number of input ports and output ports is four). A flow passage end E1 that is one end of the flow passage F11 is connected to the input port of the switching device 100. On the other hand, the flow passages F12, F13, F14 are connected to a first output port, a second output port, and a third output port of the switching device 100, respectively. The flow passage F11, the flow passage F13, and the flow passage F14 are connected at a joint portion E2. The joint portion E2 corresponds to the other end (common flow passage end) of each of the flow passages F11, F13, F14. The flow passage F12 is connected to the flow passage F13 at a joint portion E3. The joint portion E3 corresponds to the other end of the flow passage F12. The switching device 100 may be a flow regulation valve that further includes unused (unconnected) ports in addition to the four connected ports.

The flow passage F11 is provided with a pump 111, a heater 112, and a condenser 140. For example, the heater 112 is an electric high voltage heater (HVH). The flow passage F12 is provided with a heater core 114. The flow passage F13 is provided with a radiator 115. The flow passage F14 is a flow passage that joins the joint portion E2 and the third output port of the switching device 100, and includes a mixing portion M1. Details of the mixing portion M1 will be described later.

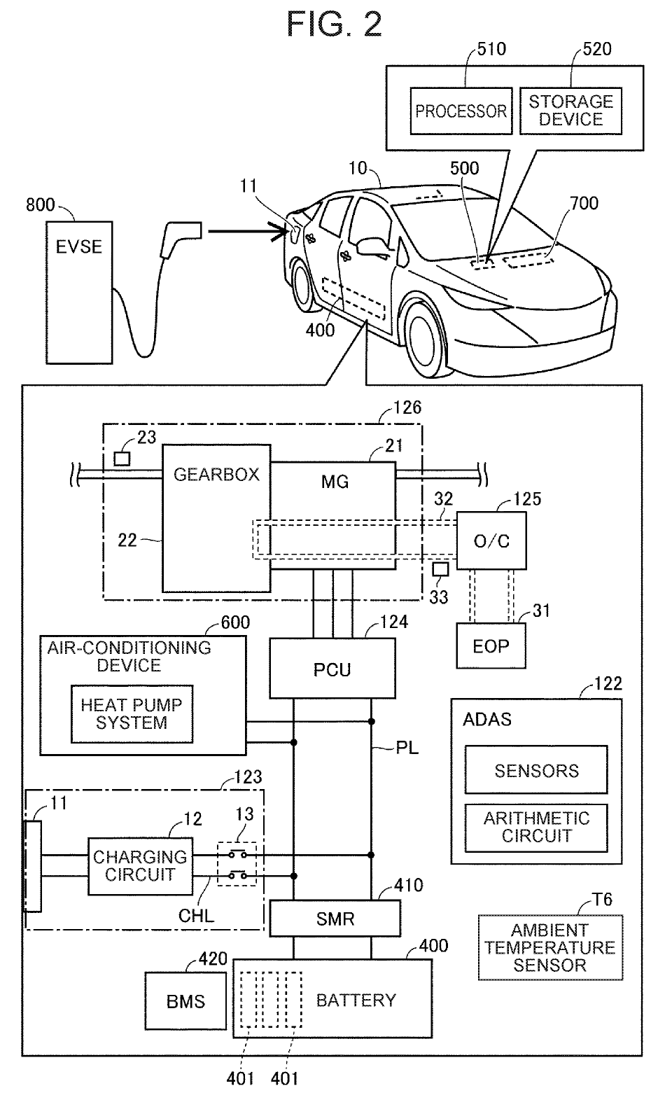

In the embodiment, the switching device 100 causes the input port to communicate with one or more output ports designated by a control device (for example, an ECU 500 shown in FIG. 2 described later). The switching device 100 couples the flow passage F11 connected to the input port, with the flow passage F12 and the flow passage F13, with the flow passage F12 and the flow passage F14, or with only the flow passage F12 or the flow passage F13, for example. The switching device 100 is configured to be able to perform switching of the coupling/decoupling between the flow passage end E1 of the flow passage F11 and each of the flow passages F12 to F14.

The thermal circuit 120 includes flow passages F2 to F4, F7, F31 to F34, F41, F42, and a switching device 300. The switching device 300 includes ports P1 to P13. Each of the ports P1, P4 to P8, P12, P13 is an output port. Each of the ports P2, P3, P9 to P11 is an input port. The switching device 300 may be a 13-way valve (for example, a flow regulation valve in which the total number of input ports and output ports is 13). The switching device 300 may be a multifunctional valve that further includes unused (unconnected) ports in addition to the 13 connected ports. The flow passage F2 and the flow passage F4 are examples of a "second flow passage" and a "first flow passage" in the present disclosure, respectively. The flow passage F3 is an example of a "third flow passage" in the present disclosure.

One end of both ends of the flow passage F2 is connected to the port P1, and the other end is connected to the port P2. The flow passage F2 is provided with a pump 121, an advanced driver assistance system (ADAS) 122, an electric supply unit (ESU) 123, a power control unit (PCU) 124, an oil cooler (O/C) 125, and a reserve tank 127. To the oil cooler 125, a transaxle (T/A) 126 is connected. The flow passage F2 includes the mixing portion M1. That is, the thermal circuit 110 and the thermal circuit 120 include the mixing portion M1 as a common portion. Details of the mixing portion M1 will be described later. The pump 121 is an example of a "pump" in the present disclosure. Each of the PCU 124 and the transaxle 126 is an example of a "drive device" in the present disclosure. The PCU 124 and the transaxle 126 are examples of a "second device" and a "first device" in the present disclosure, respectively.

One end of the flow passage F3 is connected to the port P3. The flow passage F3 bifurcates into two flow passages (flow passages F31, F32) at a bifurcating portion E8. The bifurcating portion E8 corresponds to the other end of the flow passage F3. The flow passage F31 of the two bifurcated passages is connected to the port P7, and the flow passage F32 is connected to the port P5. One end of both ends of the flow passages F3, F31 connected at the bifurcating portion E8 is connected to the port P3, and the other end is connected to the port P7. One end of both ends of the flow passages F3, F32 connected at the bifurcating portion E8 is connected to the port P3, and the other end is connected to the port P5. The flow passage F3 is provided with a radiator 200. By the flow passage formed by the flow passage F3 and the flow passage F31 or F32, a heat medium output from the switching device 300 passes through the radiator 200 (that is, performs heat exchange with the radiator 200), and returns to the switching device 300. Further, one end of both ends of the flow passage F33 is connected to the port P3, and the other end is connected to the port P4. One end of both ends of the flow passage F34 is connected to the port P3, and the other end is connected to the port P6. By each of the flow passages F33, F34, the heat medium output from the switching device 300 returns to the switching device 300 without passing through the radiator 200. The radiator 200 is an example of a "heat exchanger" and a "radiator" in the present disclosure.

One end of both ends of the flow passage F4 is connected to the port P11, and the other end is connected to the port P12. The flow passage F4 is provided with a battery 400. By the flow passage F4, the heat medium output from the switching device 300 passes through the battery 400 (that is, performs heat exchange with the battery 400), and returns to the switching device 300. Further, one end of both ends of the flow passage F41 is connected to the port P10, and the other end is connected to the port P12. One end of both ends of the flow passage F42 is connected to the port P11, and the other end is connected to the port P13. By each of the flow passages F41, F42, the heat medium output from the switching device 300 returns to the switching device 300 without passing through the battery 400. The battery 400 is an example of a "electric storage device" in the present disclosure.

One end of both ends of the flow passage F7 is connected to the port P8, and the other end is connected to the port P9. The flow passage F7 is provided with a pump 170 and a chiller 160.

The switching device 300 includes a rotational member 310 (inner-circumference-side unit) and a housing 320 (outer-circumference-side unit). The housing 320 is formed in a ring shape (for example, a circular ring shape). The rotational member 310 is formed in a disk shape. The rotational member 310 is positioned on the inside of the housing 320. The housing 320 is provided so as to enclose an outer circumference surface of the rotational member 310. The rotational member 310 is configured to be able to rotate with respect to the housing 320. In the embodiment, the housing 320 is fixed, and the rotational member 310 is driven so as to rotate. A gap between the rotational member 310 and the housing 320 may be sealed by an unillustrated gasket.

In the interior of the rotational member 310, flow passages 301 to 304 are formed. Each of the flow passages 301 to 304 provides communication between two ports of the ports P1 to P13 in the interior of the rotational member 310. Combinations (four pairs) of ports that are connected by the flow passages 301 to 304 are determined by the rotational position (rotational angle) of the rotational member 310.

The rotational member 310 rotates depending on an instruction from the control device (for example, the ECU 500 shown in FIG. 2 described later). For example, the control device gives an instruction about a rotational amount or rotational position, to an actuator (not illustrated) that rotates the rotational member 310. For example, the rotational member 310 rotates such that a center R2 thereof is adopted as a rotation axis. In the embodiment, the rotational position of the rotational member 310 is expressed as an angle between a reference position R0 of the housing 320 and a reference position R1 of the rotational member 310. The connection manner among the ports in the interior of the rotational member 310 changes depending on the rotational position of the rotational member 310. Specifically, the rotational member 310 rotates relative to the housing 320, and thereby, respective connection destinations of the flow passages 301 to 304 change. Thereby, among the ports P1 to P13, ports in a disconnected state become a connected state, ports in the connected state becomes the disconnected state, or connected destinations of ports in the connected state change.

The thermal circuit 150 includes various apparatuses that perform temperature regulation through a refrigeration cycle (that is, a cycle including an evaporation stroke, a compression stroke, a condensation stroke, and an expansion stroke). More specifically, the thermal circuit 150 includes flow passages F51, F52. The flow passage F51 forms a circuit through which a heat medium is circulated. The flow passage F51 is provided with a compressor 151, an expansion valve 155, a condenser 140 (heat exchanger), and a chiller 160. The flow passage F52 is provided with an expansion valve 152, an evaporator 153, and an evaporative pressure regulator (EPR) 154. One end of both ends of the flow passage F52 is connected to the flow passage F51 at a diversion portion E4, and the other end is connected to the flow passage F51 at a joint portion E5. The diversion portion E4 corresponds to an upstream end of the flow passage F52. The joint portion E5 corresponds to a downstream end of the flow passage F52.

The thermal circuit 110 and the thermal circuit 150 are separated from each other, and do not communicate with each other. However, the flow passage F11 of the thermal circuit 110 and the flow passage F51 of the thermal circuit 150 are connected through the condenser 140, such that mutual heat exchange can be performed. The condenser 140 is connected to both of the thermal circuit 110 and the thermal circuit 150. Further, the radiator 115 of the thermal circuit 110 and the radiator 200 of the thermal circuit 120 are configured such that mutual heat exchange can be performed. The radiators 115, 200 are disposed so as to be so close that heat exchange can be performed.

The thermal circuit 120 and the thermal circuit 150 are separated from each other, and do not communicate with each other. However, the flow passage F7 of the thermal circuit 120 and the flow passage F51 of the thermal circuit 150 are connected through the chiller 160, such that mutual heat exchange can be performed. The chiller 160 is connected to both of the thermal circuit 120 and the thermal circuit 150.

A first heat medium flows through each of the thermal circuit 110 and the thermal circuit 120. A second heat medium flows through the thermal circuit 150. In the embodiment, the heat medium (first heat medium) of the same type as the heat medium flowing through the thermal circuit 110 flows through the thermal circuit 120. As each of the first and second heat media, a known heat medium can be employed. Examples of the second heat medium include a hydrofluorocarbon-based refrigerant, a hydrofluoroolefin-based refrigerant, a carbon dioxide gas (CO₂), and a propane gas. In the embodiment, as the first heat medium, a liquid-form heat medium (for example, water or a liquid coolant other than water) is employed. Examples of the liquid coolant other than water include an insulation oil and an antifreeze liquid (for example, a long life coolant (LLC)). In the embodiment, each of the pumps 111, 121, 170 is a water pump (W/P).

The pumps 111, 121, 170 are provided with pump sensors PS1, PS2, PS3, respectively. Each of the pump sensors PS1 to PS3 is configured to detect the state (for example, the rotation speed, the electric current, and the temperature) of the corresponding pump. Further, the flow passages F11, F2, F3, F4, F51, F7 are provided with flow passage sensors T1, T2, T3, T4, T5, T7, respectively. Each of the flow passage sensors T1 to T5, T7 includes a temperature sensor that detects the temperature of the heat medium in the corresponding flow passage, and a flow rate sensor that measures the flow rate of the heat medium that flows through the corresponding flow passage. The flow passage sensor T4 is an example of a "medium-temperature detection device" in the present disclosure.

The battery 400 and the transaxle 126 are provided with a device sensor T11 and a device sensor T12, respectively. The device sensor T11 detects the temperatures of at least two of a plurality of electric storage cells 401 included in the battery 400. For example, the device sensor T11 detects the temperatures of all of the electric storage cells 401. The device sensor T12 detects the temperature of the transaxle 126. The device sensor T11 and the device sensor T12 are examples of a "cell-temperature detection device" and a "device-temperature detection device" in the present disclosure, respectively.

FIG. 2 is a diagram showing an example of a configuration of a vehicle that is equipped with the heat management system 1. With reference to FIG. 1 and FIG. 2, a vehicle 10 is an electrified vehicle (xEV) that is equipped with the heat management system 1. The vehicle 10 is configured to be able to travel using electric power output from the battery 400. The battery 400 functions as an electric storage device for drive. The battery 400 may include the electric storage cells 401 (secondary batteries), such as a lithium-ion battery, a nickel-hydrogen battery, or a sodium-ion battery, for example. That is, the electric storage cells 401 may form an assembled battery. The type of the electric storage cell 401 may be a liquid secondary battery or an all-solid-state secondary battery. Instead of a secondary battery, another electric storage device (for example, an electric double-layer capacitor) may be employed. The vehicle 10 is, for example, a battery electric vehicle (BEV) that does not include an internal combustion engine. However, the vehicle 10 is not limited to this and may be a plug-in hybrid electric vehicle (PHEV) including an internal combustion engine or another electrified vehicle (xEV). In FIG. 2, for simplification, only three electric storage cells 401 are illustrated.

The vehicle 10 includes the electronic control unit (ECU) 500 and a human machine interface (HMI) 700. The HMI 700 functions as an interface between a user and the ECU 500. The HMI 700 includes an input device and a notification device. The input device accepts an input (for example, an operation to an operation unit, or a voice input) from the user. The notification device notifies the user by display or sound (including voice). For example, the HMI 700 is an in-vehicle HMI. Instead, a mobile terminal that can be carried by the user may be employed as the HMI.

The ECU 500 includes a processor 510 and a storage device 520. Examples of the processor 510 include a central processing unit (CPU). The number of processors included in the ECU 500 may be one, or may be two or more. The storage device 520 may include at least one of a hard disk drive (HDD), a solid-state drive (SSD), and a non-volatile memory. In the storage device 520 of the ECU 500, other than programs, a variety of information that is used in the programs is stored. In the embodiment, the processor 510 executes programs stored in the storage device 520, and thereby, the ECU 500 executes various controls. However, these processes may be executed by hardware (for example, a logic circuit, such as a wired logic) alone without using software.

The vehicle 10 further includes a pump (electric oil pump (EOP)) 31, an oil circuit 32, a system main relay (SMR) 410, a battery management system (BMS) 420, an air-conditioning device 600, and an ambient temperature sensor T6. The ambient temperature sensor T6 is configured to detect the ambient temperature around the vehicle 10 (the temperature of ambient air in the periphery of the vehicle 10). The oil circuit 32 is an example of a "fourth flow passage" in the present disclosure.

The battery 400 applies a voltage to an electric power source line PL. The vehicle 10 may further include an unillustrated auxiliary machine battery. The auxiliary machine battery may provide electric power (for example, electric power for driving auxiliary machines) having a lower voltage than the voltage of the battery 400 (electric power source line PL). The SMR 410 is positioned on the electric power source line PL between the battery 400 and the PCU 124. The BMS 420 includes various sensors that detect the state (for example, the voltage, the electric current, and the temperature) of the battery 400, and outputs detection results to the ECU 500. In addition to the above sensor function, the BMS 420 may further have at least one of a state-of-charge (SOC) estimation function and a state-of-health (SOH) estimation function. The pump 31, the ESU 123, the PCU 124, the SMR 410, and the air-conditioning device 600 are controlled by the ECU 500.

The air conditioning device 600 is connected to the electric power source line PL and receives the supply of electric power from the battery 400. In the vehicle 10, the thermal circuit 110 (FIG. 1) is constituted by an air-heating circuit of the air-conditioning device 600, and the thermal circuit 150 (FIG. 1) is constituted by an air-cooling circuit of the air-conditioning device 600. The air-conditioning device 600 is configured to execute the air heating in a vehicle cabin, using the heat generated by the heater 112 (FIG. 1). The air-conditioning device 600 further includes a heat pump system. The air-conditioning device 600 can also perform heat pump air-heating using waste heat.

When the SMR 410 is in a connected state, the battery 400 applies a voltage to the PCU 124. The PCU 124 functions as a drive circuit for the transaxle 126. Specifically, the transaxle 126 of the vehicle 10 includes a motor generator (MG) 21, a gearbox 22, and a wheel speed sensor 23. The MG 21 functions as a drive motor and rotates drive wheels of the vehicle 10. The number of drive motors in the vehicle 10 is not limited, and the motor may be provided for each axle or for each wheel. The PCU 124 is connected to the electric power source line PL, and drives the MG 21 using electric power supplied from the battery 400. For example, the PCU 124 includes an inverter. For example, the gearbox 22 includes a speed reducer and a differential gear device. The MG 21 converts electric power into torque. This torque is transmitted to the drive wheels of the vehicle 10 through the gearbox 22. The MG 21 performs electric power regeneration, for example, during the deceleration of the vehicle 10, and charges the battery 400. The wheel speed sensor 23 is provided at the wheel of the vehicle 10, or the axle that rotates along with the wheel, and detects the rotation speed of the wheel.

The transaxle 126 further includes an unillustrated brake device and steering device. The ADAS 122 may control the transaxle 126 for driving assistance. The ADAS 122 includes apparatuses (including an arithmetic circuit for information processing) and sensors (including an environment recognition sensor, such as a camera, a millimeter-wave radar, or a LIDAR) for driving assistance.

The pump 31 circulates lubricant through the oil circuit 32. The oil circuit 32 is provided with a temperature sensor 33 that detects the temperature of oil (lubricant) in the oil circuit 32. The oil cooler 125 is connected to both of the flow passage F2 (FIG. 1) and the oil circuit 32, and functions as a heat exchanger. The oil cooler 125 cools the lubricant in the oil circuit 32 using the heat medium flowing through the flow passage F2. The oil circuit 32 supplies the lubricant to the MG 21 and the gearbox 22, and cools the MG 21 and the gearbox 22 by the lubricant. However, without being limited to this, the method of cooling the periphery of the motor can be changed as appropriate. For example, one of the MG 21 and the gearbox 22 may be oil-cooled by the oil circuit 32, and the other may be water-cooled by the flow passage F2.

The vehicle 10 is configured to allow execution of external charging (charging of the battery 400 with electric power from the exterior of the vehicle). The ESU 123 is provided at a charging line CHL, and includes an inlet 11, a charging circuit 12 (in-vehicle charger), and a charging relay 13. The charging relay 13 performs switching between connection and disconnection of the charging line CHL. The ECU 500 puts the charging relay 13 and the SMR 410 in a connected state before the external charging is started, and controls the ESU 123 during the execution of the external charging. When a leading end portion (connector) of a charging cable linked with electric vehicle supply equipment (EVSE) 800 is connected to the inlet 11 of the vehicle 10 in a parked state (plug-in) as shown in FIG. 2, the vehicle 10 is electrically connected to the EVSE 800. The charging circuit 12 charges the battery 400 using electric power input from the EVSE 800 to the inlet 11. The ESU 123 may further include a circuit (discharging circuit) for external electricity feeding (electricity feeding to the exterior of the vehicle with the electric power of the battery 400). The ESU 123 may have a vehicle-to-home (V2H) function and/or a vehicle-to-load (V2L) function. The charging circuit 12 may function as a charging and discharging circuit. In the example shown in FIG. 2, one end of the charging line CHL is connected to between the SMR 410 and the PCU 124, and the other end of the charging line CHL is connected to the inlet 11. However, without being limited to this, one end of the charging line CHL may be connected to between the battery 400 and the SMR 410.

A plurality of in-vehicle apparatuses shown in FIG. 2 may be integrated as an electric axle (eAxle) having an "Xin1" structure. Examples of the "Xin1" structure include a "3in1" structure in which a drive motor, an inverter, and a gearbox are integrated, a "6in1" structure in which a DC/DC converter, an in-vehicle charger, and a BMS are further integrated, and an "8in1" structure in which an electric power distribution unit (PDU) and an ECU are integrated. The electric axle may be provided at each of a front and a rear of the vehicle 10. The thermal circuit 120 may be configured to be able to cool these electric axles.

As described above, the vehicle 10 according to the embodiment includes the heat management system 1 shown in FIG. 1. In the vehicle 10, the PCU 124 is cooled by the heat medium flowing through the flow passage F2. The lubricant in the oil circuit 32 is cooled by the heat medium flowing through the flow passage F2, and the MG 21 is cooled by this lubricant. Thus, the flow passage F2 is configured to be able to cool the PCU 124 and the transaxle 126 by the heat medium. The battery 400 is cooled by the heat medium flowing through the flow passage F4. The flow passage F4 is configured to be able to cool the battery 400 by the heat medium. The radiator 200 is configured to cool the heat medium flowing through the flow passage F3. The pumps (pumps 111, 121, 170) that circulate the heat medium are controlled by the ECU 500. The ECU 500 may execute a pulse width modulation (PWM) control of each pump, using a pump drive signal. For example, the pump drive signal indicates a duty ratio (the ratio of a high-level period to a cycle length) for a drive instruction (high-level and low-level drive signals) to the pump. The ECU 500 (processor 510) may acquire the state of the vehicle 10 using outputs of the various sensors shown in FIG. 1 and FIG. 2, and may control the heat management system 1 (for example, the pumps and the switching devices) based on the acquired state of the vehicle 10.

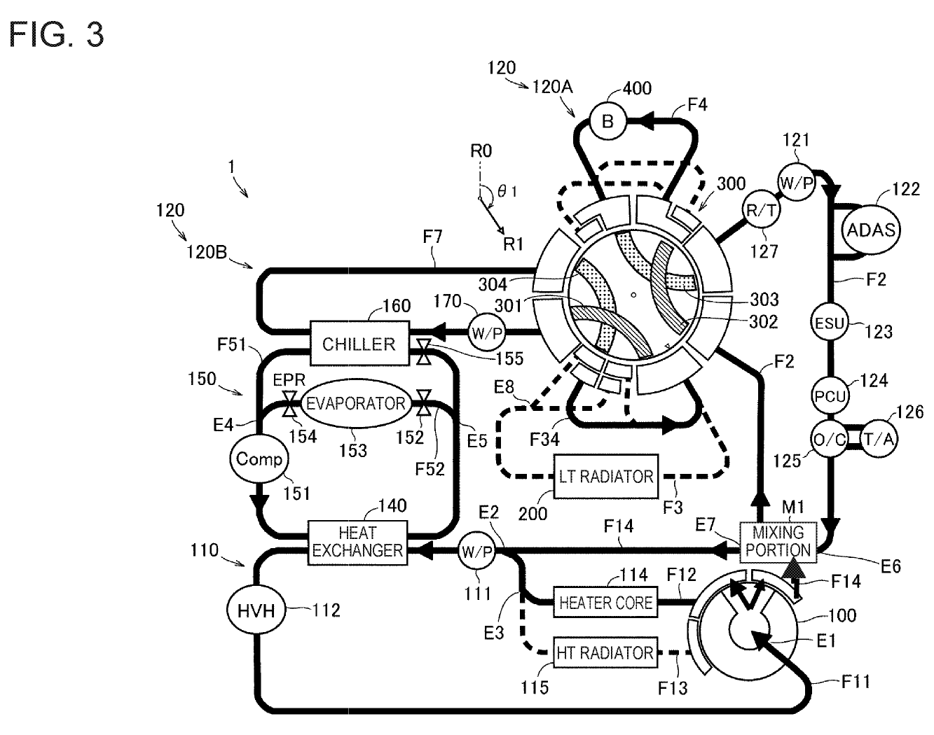

The heat management system 1 includes the thermal circuit 110 and the thermal circuit 120. The thermal circuit 110 and the thermal circuit 120 include the mixing portion M1 as a common portion. More specifically, the thermal circuit 110 includes the flow passage F11 including the pump 111, the flow passage F14 including the mixing portion M1, and the switching device 100. The switching device 100 is configured to be able to perform switching of the coupling/decoupling between the flow passage end E1 of the flow passage F11 and the flow passage F14. The thermal circuit 120 includes the flow passage F2 including the pump 121 and the mixing portion M1. The flow passages F2, F14 are jointed at a joint portion E6 that is one end of the mixing portion M1, and the flow passages F2, F14 are separated at a diversion portion E7 that is the other end of the mixing portion M1. In the embodiment, the ECU 500 executes a cooperative control of the pumps 111, 121, such that the heat medium circulated through the thermal circuit 110 by the pump 111 and the heat medium circulated through the thermal circuit 120 by the pump 121 are mixed at the mixing portion M1, when the flow passage end E1 of the flow passage F11 is connected to the flow passage F14 through the switching device 100. The control manner of the heat management system 1 by the ECU 500 will be described below with reference to FIG. 3 to FIG. 6.

FIG. 3 is a diagram showing the heat management system 1 in a first pattern. With reference to FIG. 3, in the first pattern, the switching device 100 couples the flow passage end E1 of the flow passage F11 connected to the input port, with each of the flow passages F12, F14. The heat medium circulated through the thermal circuit 110 by the pump 111 flows from the flow passage F11 to each of the flow passages F12, F14 via the switching device 100. In the first pattern, the switching device 300 is controlled such that the rotational position of the rotational member 310 (FIG. 1) becomes an angle Θ1. Moreover, the switching device 300 divides the thermal circuit 120 into two thermal circuits 120A, 120B shown in FIG. 3. The thermal circuit 120A corresponds to a fluid circuit that starts from the flow passage F2, passes through the flow passage 302, the flow passage F4, and the flow passage 303, and returns to the flow passage F2. The thermal circuit 120B corresponds to a fluid circuit that starts from the flow passage F7, passes through the flow passage 304, the flow passage F34, and the flow passage 301, and returns to the flow passage F7. The thermal circuit 120A is an example of a "first flow passage circuit" in the present disclosure.

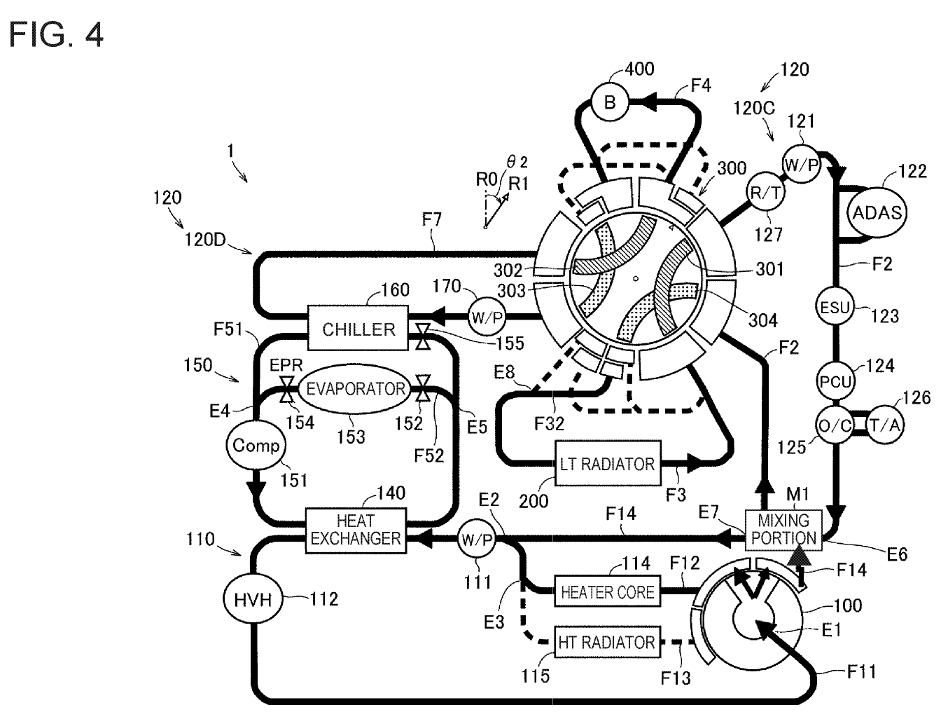

FIG. 4 is a diagram showing the heat management system 1 in a second pattern. With reference to FIG. 4, in the second pattern, the switching device 100 couples the flow passage end E1 of the flow passage F11 connected to the input port, with each of the flow passages F12, F14. The heat medium circulated through the thermal circuit 110 by the pump 111 flows from the flow passage F11 to each of the flow passages F12, F14 via the switching device 100. In the second pattern, the switching device 300 is controlled such that the rotational position of the rotational member 310 (FIG. 1) becomes an angle Θ2. Moreover, the switching device 300 divides the thermal circuit 120 into two thermal circuits 120C, 120D shown in FIG. 4. The thermal circuit 120C corresponds to a fluid circuit that starts from the flow passage F2, passes through the flow passage 304, the flow passage F32, the flow passage F3, and the flow passage 301, and returns to the flow passage F2. The thermal circuit 120D corresponds to a fluid circuit that starts from the flow passage F7, passes through the flow passage 302, the flow passage F4, and the flow passage 303, and returns to the flow passage F7. The thermal circuit 120D is an example of a "second flow passage circuit" in the present disclosure.

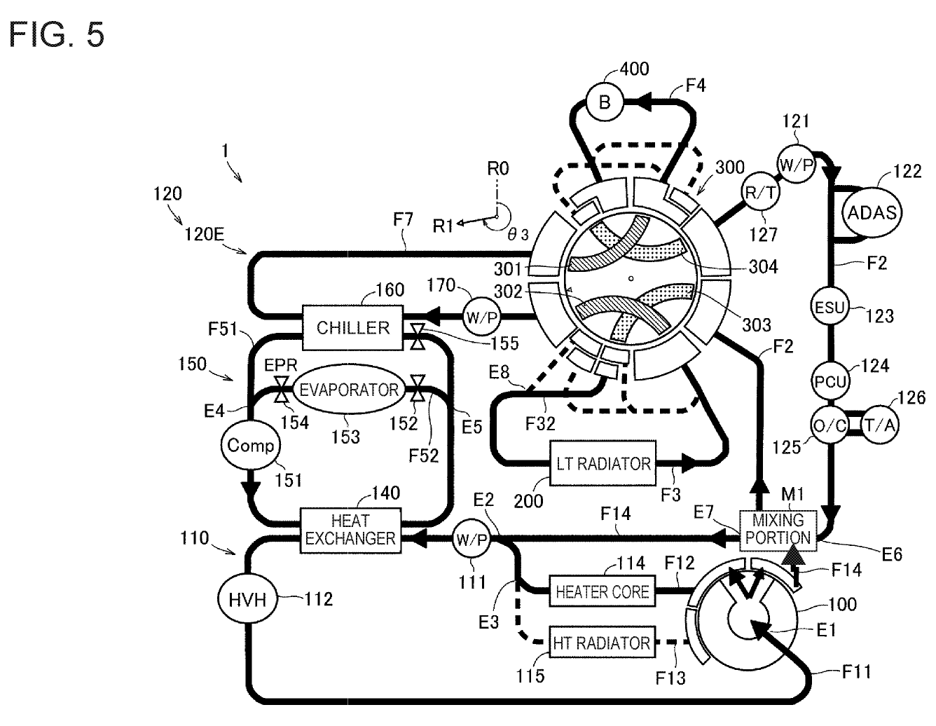

FIG. 5 is a diagram showing the heat management system 1 in a third pattern. With reference to FIG. 5, in the third pattern, the switching device 100 couples the flow passage end E1 of the flow passage F11 connected to the input port, with each of the flow passages F12, F14. The heat medium circulated through the thermal circuit 110 by the pump 111 flows from the flow passage F11 to each of the flow passages F12, F14 via the switching device 100. In the third pattern, the switching device 300 is controlled such that the rotational position of the rotational member 310 (FIG. 1) becomes an angle Θ3. Specifically, the ECU 500 controls the switching device 300 such that the thermal circuit 120 has the pattern shown in FIG. 5. The thermal circuit 120 shown in FIG. 5 includes a thermal circuit 120E shown in FIG. 5. The thermal circuit 120E corresponds to a fluid circuit that starts from the flow passage F2, passes through the flow passage 303, the flow passage F32, the flow passage F3, the flow passage 302, the flow passage F7, the flow passage 301, the flow passage F4, and the flow passage 304, and returns to the flow passage F2. The thermal circuit 120E is an example of a "third flow passage circuit" in the present disclosure.

The ECU 500 (processor 510) executes a control to perform the temperature rise of the battery 400 before the start of the charging of the battery 400 (or during the charging), for example. Thereby, it is possible to enhance the charging efficiency of the battery 400. Specifically, the ECU 500 may perform the temperature rise of the battery 400, using the heat produced in the transaxle 126, the PCU 124, and the like. The control (referred to as a temperature rise control, hereinafter) to perform the temperature rise of the battery 400 is an example of a "temperature rise control" in the present disclosure.

When the temperature rise of the battery is performed, the temperatures of the electric storage cells included in the battery vary in some cases. For eliminating the variation in temperature among the electric storage cells, it is possible that heat exchange is performed between the electric storage device and a heat medium, such as coolant. In this case, it is desirable to restrain the temperature of the battery from excessively rising (falling) due to the heat exchange between the battery and the heat medium.

Hence, in the embodiment, the switching device 300 forms the thermal circuit 120A (FIG. 3) in the first pattern after the temperature rise control, when the temperature of the heat medium in the flow passage F4 that is detected by the flow passage sensor T4 is less than a threshold Tb. Further, the switching device 300 forms the thermal circuit 120D (FIG. 4) in the second pattern after the temperature rise control, when the temperature of the heat medium in the flow passage F4 that is detected by the flow passage sensor T4 is in a temperature range of more than or equal to the threshold Tb and less than or equal to a threshold Tc. The threshold Tc is more than the threshold Tb. Further, the above temperature range may be a temperature range suitable for the charging and others of the battery 400. The threshold Tc is an example of a "second threshold" in the present disclosure.

By forming the thermal circuit 120A, the variation in temperature among the electric storage cells can be restrained by the heat medium that is circulated through the thermal circuit 120A (temperature equalization), and therewith, the temperature rise of the heat medium in the thermal circuit 120A can be performed by the heat of the transaxle 126 and the like, As a result, it is possible to restrain the temperature of the battery 400 from excessively falling, while restraining the variation in temperature among the electric storage cells 401. Further, by forming the thermal circuit 120D, the variation in temperature among the electric storage cells 401 can be restrained by the heat medium that is circulated through the thermal circuit 120D, and therewith, the temperature rise of the battery 400 due to the heat of the transaxle 126 and the like can be restrained. As a result, it is possible to restrain the temperature of the battery 400 from excessively rising, while restraining the variation in temperature among the electric storage cells 401.

### Control Flow

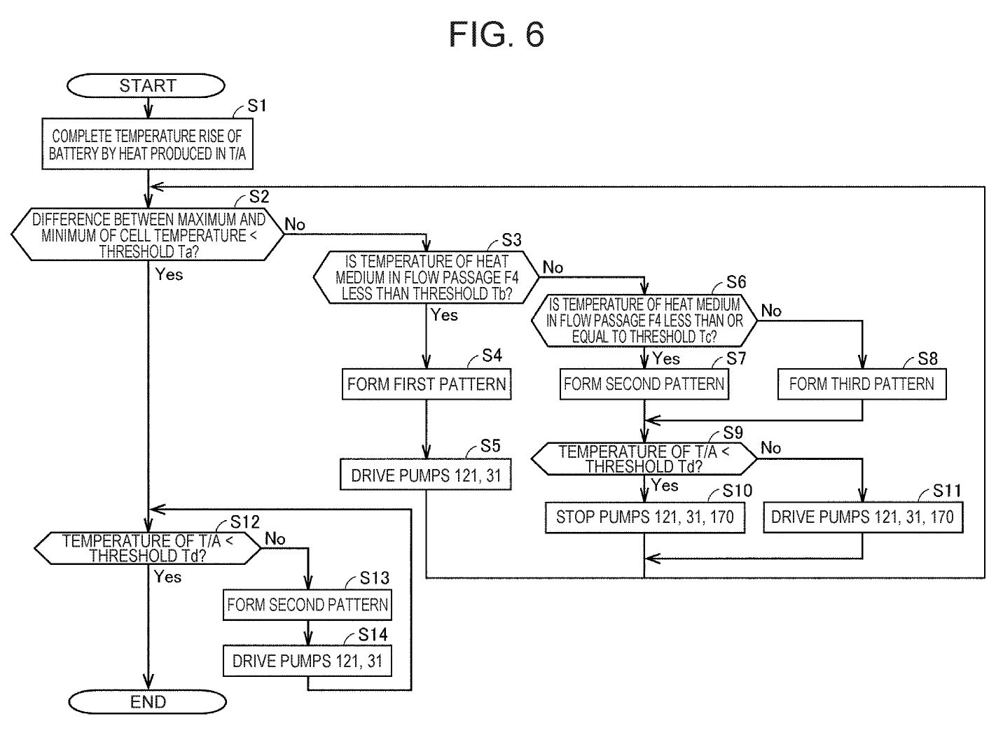

With reference to FIG. 6, a control flow of the heat management system 1 according to the embodiment will be described. The control shown in FIG. 6 is a control that is processed by the ECU 500 (processor 510).

In step S1, the ECU 500 completes the temperature rise control of the battery 400, by the heat produced in the transaxle 126 (PCU 124). In step S1, the temperature rise of the battery 400 may be performed by the heat of a heater, for example.

In step S2, the ECU 500 determines whether the temperature difference between an electric storage cell 401 having the highest temperature and an electric storage cell 401 having the lowest temperature is less than a threshold Ta, based on the detection value of the device sensor T11. When the above temperature difference is less than the threshold Ta (Yes in S2), the process proceeds to step S12. When the above temperature difference is more than or equal to the threshold Ta (No in S2), the process proceeds to step S3. The above temperature difference is an example of a "value based on the difference" in the present disclosure. The threshold Ta is an example of a "cell-temperature threshold" in the present disclosure.

In step S3, the ECU 500 determines whether the temperature of the heat medium in the flow passage F4 is less than the threshold Tb, based on the detection value of the flow passage sensor T4. When the detection value (the temperature of the heat medium in the flow passage F4) of the flow passage sensor T4 is less than the threshold Tb (Yes in S3), the process proceeds to step S4. When the detection value (the temperature of the heat medium in the flow passage F4) of the flow passage sensor T4 is more than or equal to the threshold Tb (No in S3), the process proceeds to step S6. The threshold Tb is an example of a "first threshold" in the present disclosure.

In step S4, the ECU 500 forms the first pattern (FIG. 3), by controlling the switching device 300 such that the rotational position of the rotational member 310 (FIG. 1) becomes the angle Θ1. Next, the process proceeds to step S5.

In step S5, the ECU 500 drives the pump 121 and the pump 31. Thereby, the heat medium is circulated through the thermal circuit 120A, and the lubricant is circulated through the oil circuit 32. Thereafter, the process returns to step S2. Thereby, in the oil cooler 125, heat exchange is performed between the heat medium and the lubricant. As a result, the temperature rise of the heat medium is performed.

In step S6, the ECU 500 determines whether the temperature of the heat medium in the flow passage F4 is in the temperature range of more than or equal to the threshold Tb and less than or equal to the threshold Tc, based on the detection value of the flow passage sensor T4. When the detection value (the temperature of the heat medium in the flow passage F4) of the flow passage sensor T4 is in the above temperature range (Yes in S6), the process proceeds to step S7. When the detection value (the temperature of the heat medium in the flow passage F4) of the flow passage sensor T4 is more than the threshold Tc (No in S6), the process proceeds to step S8.

In step S7, the ECU 500 forms the second pattern (FIG. 4), by controlling the switching device 300 such that the rotational position of the rotational member 310 (FIG. 1) becomes the angle Θ2. Next, the process proceeds to step S9.

In step S8, the ECU 500 forms the third pattern (FIG. 5), by controlling the switching device 300 such that the rotational position of the rotational member 310 (FIG. 1) becomes the angle Θ3. Next, the process proceeds to step S9.

In step S9, the ECU 500 determines whether the temperature of the transaxle 126 is less than a threshold Td, based on the detection value of the device sensor T12. When the temperature of the transaxle 126 is less than the threshold Td (Yes in S9), the process proceeds to step S10. When the temperature of the transaxle 126 is more than or equal to the threshold Td (No in S9), the process proceeds to step S11. The threshold Td may be a value (for example, the upper limit or lower limit in the above temperature range) in a temperature range suitable for leaving the transaxle 126. The threshold Td is an example of a "threshold" in the present disclosure.

In step S10, the ECU 500 stops at least one of the pump 121 and the pump 31. For example, the ECU 500 stops both of the pump 121 and the pump 31. Further, the ECU 500 stops also the pump 170. Thereby, it is possible to restrain the heat release of the transaxle 126. When the second pattern has been formed, the ECU 500 may drive the pump 170. In this case, the ECU 500 may stop the compressor 151. Next, the process returns to step S2.

In step S11, the ECU 500 drives the pump 121 and the pump 31. Further, the ECU 500 drives also the pump 170. When the third pattern has been formed, the ECU 500 may drive only one of the pump 121 and the pump 170. When the second pattern has been formed, the ECU 500 may stop the pump 170. Next, the process returns to step S2.

In step S12, the ECU 500 determines whether the temperature of the transaxle 126 is less than the threshold Td, based on the detection value of the device sensor T12. When the temperature of the transaxle 126 is less than the threshold Td (Yes in S12), the process ends. When the temperature of the transaxle 126 is more than or equal to the threshold Td (No in S12), the process proceeds to step S13. The threshold in step S12 may be a value different from the threshold Td.

In step S13, the ECU 500 forms the second pattern (FIG. 4), by controlling the switching device 300 such that the rotational position of the rotational member 310 (FIG. 1) becomes the angle Θ2. Next, the process proceeds to step S14.

In step S14, the ECU 500 drives the pump 121 and the pump 31. The ECU 500 may stop the pump 170. Next, the process returns to step S12.

The flow shown in FIG. 6 is merely an example, and is not limited to the above example. For example, steps S5, S9 to S11, S14 and others may be excluded.

As described above, in the embodiment, the switching device 300 forms the thermal circuit 120A after the temperature rise control, when the detection value of the flow passage sensor T4 is less than the threshold Tb, and forms the thermal circuit 120D after the temperature rise control, when the detection value of the flow passage sensor T4 is in the temperature range that is more than or equal to the threshold Tb and less than or equal to the threshold Tc. Therefore, by the formation of the thermal circuit 120A, it is possible to restrain the variation in temperature among the electric storage cells 401, because the heat medium flows through the flow passage F4, and it is possible to restrain the temperature of the battery 400 from falling, using the heat of the transaxle 126. Furthermore, since the transaxle 126 is cooled, it is possible to restrain the transaxle 126 from being affected by heat (for example, from being deteriorated by heat) due to the maintenance of the high-temperature state of the transaxle 126. Further, by the formation of the thermal circuit 120D, it is possible to restrain the variation in temperature among the electric storage cells 401, because the heat medium flows through the flow passage F4, and it is possible to restrain the temperature of the battery 400 from rising by the heat of the transaxle 126, because the transaxle 126 and the battery 400 are thermally isolated from each other.

### Modification

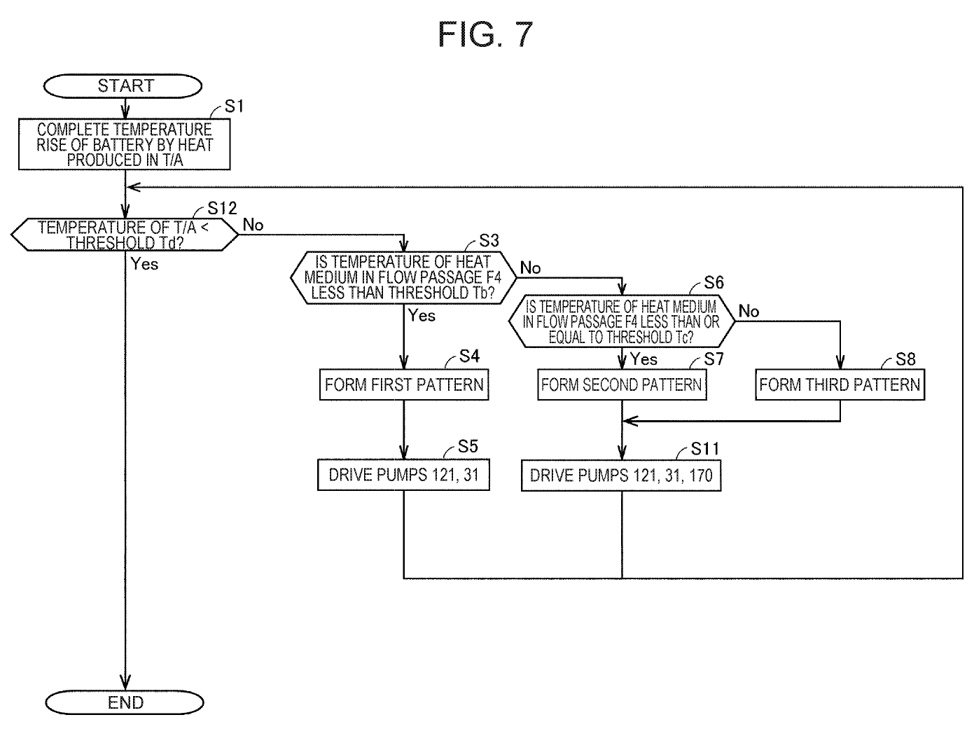

FIG. 7 shows a modification of the flowchart of FIG. 6. Detailed descriptions about steps for the same processes as those in FIG. 6 are omitted.

After the temperature rise control in step S1, the determination in step S12 is performed. When the temperature of the transaxle 126 is less than the threshold Td (Yes in S12), the process ends. When the temperature of the transaxle 126 is more than or equal to the threshold Td (No in S12), the process proceeds to step S3. The threshold in step S12 of FIG. 7 may be a value different from the threshold in step S12 of FIG. 6.

In the flow of FIG. 7, the process in step S11 is executed following each of step S7 and step S8. The other processes are the same as the processes in FIG. 6.

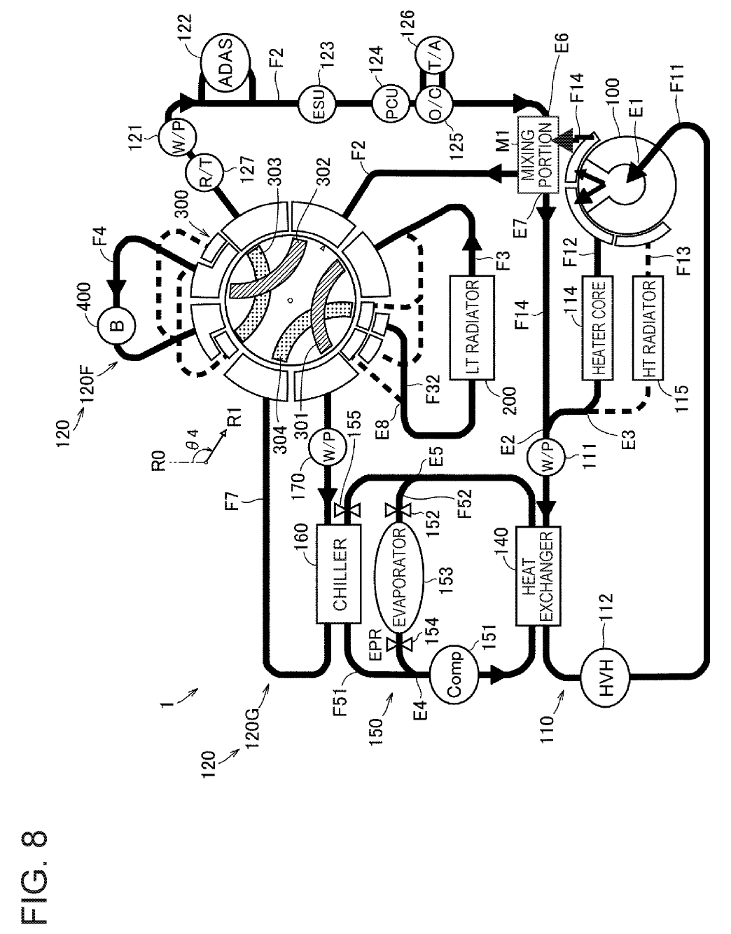

FIG. 8 is a first modification of the first pattern in FIG. 3. In FIG. 8, the switching device 100 couples the flow passage end E1 of the flow passage F11 connected to the input port, with each of the flow passages F12, F14. The heat medium circulated through the thermal circuit 110 by the pump 111 flows from the flow passage F11 to each of the flow passages F12, F14 via the switching device 100. The switching device 300 is controlled such that the rotational position of the rotational member 310 (FIG. 1) becomes an angle Θ4. Moreover, the switching device 300 divides the thermal circuit 120 into two thermal circuits 120F, 120G shown in FIG. 8. The thermal circuit 120F corresponds to a fluid circuit that starts from the flow passage F2, passes through the flow passage 302, the flow passage F4, and the flow passage 303, and returns to the flow passage F2. The thermal circuit 120G corresponds to a fluid circuit that starts from the flow passage F7, passes through the flow passage 304, the flow passage F32, the flow passage F3, and the flow passage 301, and returns to the flow passage F7. The thermal circuit 120F is an example of the "first flow passage circuit" in the present disclosure.

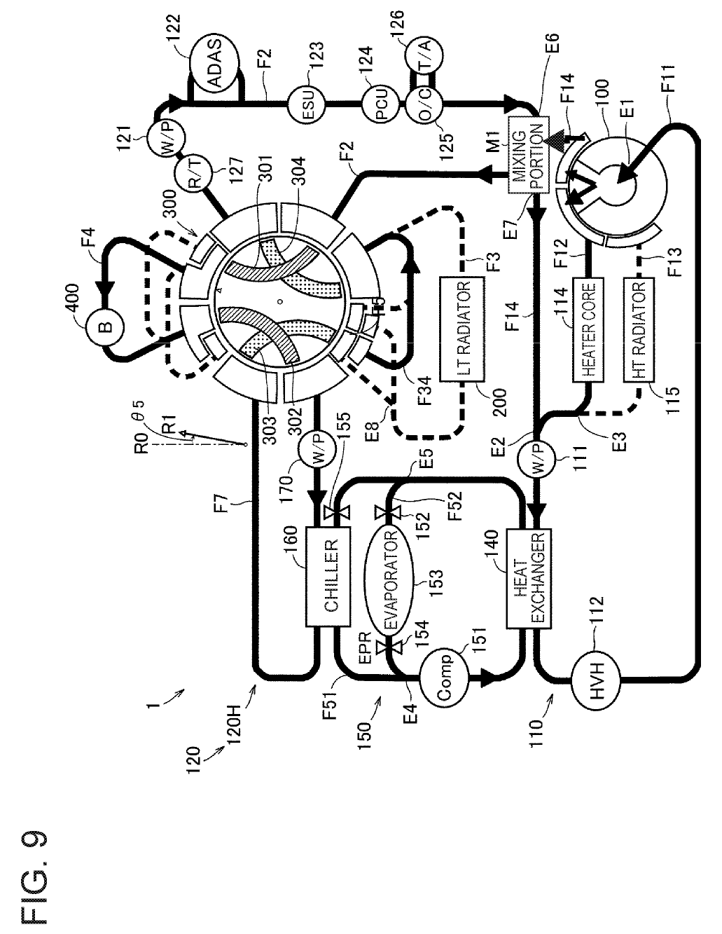

FIG. 9 is a second modification of the first pattern in FIG. 3. In FIG. 9, the switching device 100 couples the flow passage end E1 of the flow passage F11 connected to the input port, with each of the flow passages F12, F14. The heat medium circulated through the thermal circuit 110 by the pump 111 flows from the flow passage F11 to each of the flow passages F12, F14 via the switching device 100. The switching device 300 is controlled such that the rotational position of the rotational member 310 (FIG. 1) becomes an angle Θ5. Specifically, the ECU 500 controls the switching device 300 such that the thermal circuit 120 has the pattern shown in FIG. 9. The thermal circuit 120 shown in FIG. 9 includes a thermal circuit 120H. The thermal circuit 120H corresponds to a fluid circuit that starts from the flow passage F2, passes through the flow passage 301, the flow passage F4, the flow passage 302, the flow passage F7, the flow passage 303, the flow passage F34, and the flow passage 304, and returns to the flow passage F2. In this case, the compressor 151 may be stopped. The thermal circuit 120H is an example of the "first flow passage circuit" in the present disclosure.

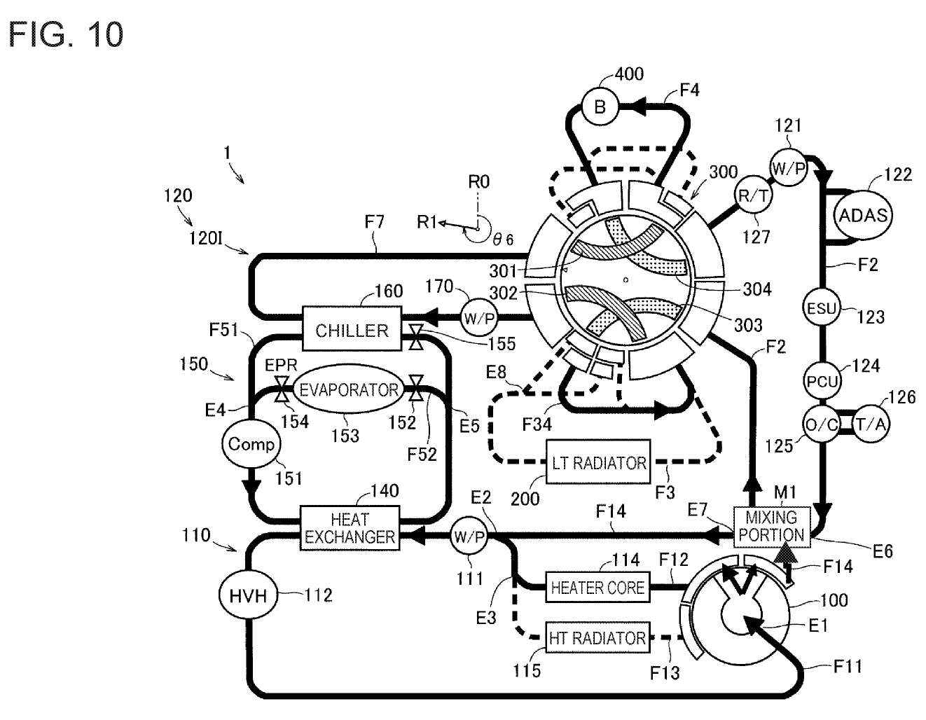

FIG. 10 is a third modification of the first pattern in FIG. 3. In FIG. 10, the switching device 100 couples the flow passage end E1 of the flow passage F11 connected to the input port, with each of the flow passages F12, F14. The heat medium circulated through the thermal circuit 110 by the pump 111 flows from the flow passage F11 to each of the flow passages F12, F14 via the switching device 100. The switching device 300 is controlled such that the rotational position of the rotational member 310 (FIG. 1) becomes an angle Θ6. Specifically, the ECU 500 controls the switching device 300 such that the thermal circuit 120 has the pattern shown in FIG. 10. The thermal circuit 120 shown in FIG. 10 includes a thermal circuit 120I. The thermal circuit 120I corresponds to a fluid circuit that starts from the flow passage F2, passes through the flow passage 303, the flow passage F34, the flow passage 302, the flow passage F7, the flow passage 301, the flow passage F4, and the flow passage 304, and returns to the flow passage F2. In this case, the compressor 151 may be stopped. The thermal circuit 120I is an example of the "first flow passage circuit" in the present disclosure.

In the above embodiment, the example in which the heat of the transaxle 126 (PCU 124) is released by the radiator 200 in the second pattern and the third pattern has been shown, but the present disclosure is not limited to this. The heat of the transaxle 126 (PCU 124) may be released to the thermal circuit 150 through the chiller 160. In this case, the compressor 151 is driven. For example, when air heating is requested from the user of the vehicle 10, the heat of the transaxle 126 (PCU 124) may be released to the thermal circuit 150 through the chiller 160. Thereby, it is possible to enhance air-heating efficiency (to reduce the electric power consumed by air heating). In this case, the chiller 160 is an example of the "heat exchanger" in the present disclosure.

In the above embodiment, the example in which the heat management system 1 includes the switching device 300 that is a 13-way valve and the switching device 100 that is a four-way valve has been shown, but the present disclosure is not limited to this. The heat management system may include a plurality of multiple-way valves having a different configuration from the above description. Further, the number of multiple-way valves is not limited to two. For example, the number of multiple-way valves may be one, or three or more. Further, the multiple-way valve is not limited to a rotary-type valve, and may be constituted by a spool valve, for example.

In the above embodiment, the example in which the flow passage F2 and the flow passage F3 are connected in the second pattern has been shown, but the present disclosure is not limited to this. In the second pattern, the flow passage F2 and the flow passage F3 may be isolated.

In the above embodiment, the example in which the third pattern is formed when the temperature of the heat medium in the flow passage F4 is more than the threshold Tc in step S6 of FIG. 6 has been shown, but the present disclosure is not limited to this. For example, when it is determined in step S6 that the temperature of the heat medium in the flow passage F4 is more than the threshold Tc, the process may be ended. This modification may be applied to the flow shown in FIG. 7.

In the above embodiment, the example in which the heat medium in the thermal circuit 120A is circulated by the pump 121 in the first pattern (FIG. 3) has been shown, but the present disclosure is not limited to this. For example, the heat medium in the thermal circuit 120A may be circulated by a pump disposed at the flow passage F4.

In the above embodiment, the example in which the heat medium in the thermal circuit 120C is circulated by the pump 121 in the second pattern (FIG. 4) has been shown, but the present disclosure is not limited to this. For example, the heat medium in the thermal circuit 120C may be circulated by a pump disposed at the flow passage F3. Further, the heat medium in the thermal circuit 120D may be circulated by a pump disposed at the flow passage F4. In the third pattern (FIG. 5) also, the heat medium in the thermal circuit 120E may be circulated by a pump disposed at the flow passage F3 or the flow passage F4.

In the above embodiment, the example in which it is determined that the temperature difference between the electric storage cell 401 having the highest temperature and the electric storage cell 401 having the lowest temperature that are included in the electric storage cells 401 is less than the threshold Ta has been shown, but the present disclosure is not limited to this. For example, whether the difference between the average of the temperatures of the electric storage cells 401 and the temperature of the electric storage cell 401 having the highest temperature (or the lowest temperature) is less than a predetermined threshold may be determined. Further, instead of the detection of the temperatures of all of the electric storage cells 401, only the temperatures of some electric storage cells (for example, electric storage cells at the center and both ends in an array direction of the electric storage cells) may be detected.

In the above embodiment, the example in which the pump 121 and the pump 31 are stopped when the temperature of the transaxle 126 is less than the threshold Td in step S9 in FIG. 6 has been shown, but the present disclosure is not limited to this. Even when the temperature of the transaxle 126 is less than the threshold Td, the pump 121 and the pump 31 may be driven, and the transaxle 126 may be cooled.

The configurations and processes in the above embodiment and the above modifications may be combined with each other.

It should be construed that the embodiment disclosed here is exemplary and not restrictive in all respects. The scope of the present disclosure is indicated by the claims, not by the aforementioned description of the embodiment, and it is intended to include all alterations within the scope and sprit of the claims and equivalents.

What is claimed is:

1. A heat management system comprising:
a first flow passage configured such that a heat medium flows;
a second flow passage configured such that a heat medium flows;
a third flow passage configured such that a heat medium flows;
an electric storage device configured to perform heat exchange with the heat medium in the first flow passage and including a plurality of electric storage cells;
a drive device configured to perform heat exchange with the heat medium in the second flow passage and generate drive power;
a heat exchanger provided at the third flow passage;
a switching device configured to switch a connection state among the first flow passage, the second flow passage, and the third flow passage; and
a medium-temperature detection device configured to detect a temperature of the heat medium that flows through the first flow passage, wherein
the switching device is configured to
form a first flow passage circuit after a temperature rise control, in a case that a detection value of the medium-temperature detection device is less than a first threshold, and
form a second flow passage circuit after the temperature rise control, in a case that the detection value of the medium-temperature detection device is in a temperature range that is more than or equal to the first threshold and less than or equal to a second threshold that is more than the first threshold, the first flow passage circuit being a circuit including the first flow passage and the second flow passage that are connected to each other and being isolated from the third flow passage, the second flow passage circuit being a circuit including the first flow passage that is isolated from the second flow passage, the temperature rise control being a control to perform temperature rise of the electric storage device.

2. The heat management system according to claim 1, wherein the second flow passage circuit is a circuit in which the first flow passage is isolated from a circuit in which the second flow passage and the third flow passage are connected.

3. The heat management system according to claim 2, wherein the switching device is configured to form a third flow passage circuit after the temperature rise control, in a case that the detection value of the medium-temperature detection device is more than the second threshold, the third flow passage circuit being a circuit in which the first flow passage, the second flow passage, and the third flow passage are connected.

4. The heat management system according to claim 1, further comprising a cell-temperature detection device configured to detect temperatures of at least two electric storage cells of the electric storage cells, wherein
the switching device is configured to
form the first flow passage circuit after the temperature rise control, in a case that a value based on a difference between the temperatures of the at least two electric storage cells that are detected by the cell-temperature detection device is more than or equal to a cell-temperature threshold and the detection value of the medium-temperature detection device is less than the first threshold, and
form the second flow passage circuit after the temperature rise control, in a case that the value based on the difference is more than or equal to the cell-temperature threshold and the detection value of the medium-temperature detection device is in the temperature range.

5. The heat management system according to claim 4, wherein
the switching device is configured to form a third flow passage circuit after the temperature rise control, in a case that the value based on the difference is more than or equal to the cell-temperature threshold and the detection value of the medium-temperature detection device is more than the second threshold, the third flow passage circuit being a circuit in which the first flow passage, the second flow passage, and the third flow passage are connected.

6. The heat management system according to claim 5, further comprising:
a pump configured to circulate a heat medium through the second flow passage;
a processor configured to control drive of the pump; and
a device-temperature detection device configured to detect a temperature of the drive device, wherein
the processor is configured to
stop the pump after the temperature rise control, in a case that the value based on the difference is more than or equal to the cell-temperature threshold, that the second flow passage circuit or the third flow passage circuit has been formed, and that the temperature of the device-temperature detection device is less than a threshold, and
drive the pump after the temperature rise control, in a case that the value based on the difference is more than or equal to the cell-temperature threshold, the second flow passage circuit or the third flow passage circuit has been formed, and the temperature of the device-temperature detection device is more than or equal to the threshold.

7. The heat management system according to claim 4, further comprising a device-temperature detection device configured to detect a temperature of the drive device, wherein
the switching device is configured to form the second flow passage circuit after the temperature rise control, in a case that the value based on the difference is less than the cell-temperature threshold and a detection value of the device-temperature detection device is more than or equal to a threshold.

8. The heat management system according to claim 3, further comprising a device-temperature detection device configured to detect a temperature of the drive device, wherein
the switching device is configured to
form the first flow passage circuit after the temperature rise control, in a case that a detection value of the device-temperature detection device is more than or equal to a threshold and the detection value of the medium-temperature detection device is less than the first threshold,
form the second flow passage circuit after the temperature rise control, in a case that the detection value of the device-temperature detection device is more than or equal to the threshold and the detection value of the medium-temperature detection device is in the temperature range, and
form the third flow passage circuit after the temperature rise control, in a case that the detection value of the device-temperature detection device is more than or equal to the threshold and the detection value of the medium-temperature detection device is more than or equal to the second threshold.

9. The heat management system according to claim 2, wherein the heat exchanger includes a radiator.

10. The heat management system according to claim 1, further comprising:
an oil cooler disposed at the second flow passage; and
a fourth flow passage connected to the oil cooler and isolated from the second flow passage, wherein:
lubricant is circulated through the fourth flow passage;
the drive device includes
a first device configured to perform heat exchange with the lubricant that is circulated through the fourth flow passage, and
a second device configured to perform heat exchange with a heat medium that is circulated through the second flow passage.

11. A vehicle comprising the heat management system according to claim 1.
